(19) United States
(12) Patent Application Publication
(10) Pub. No.: US 2013/0335323 A1
(43) Pub. Date: Dec. 19, 2013

(54) CURSOR CONTROL DEVICE AND SYSTEM

(71) Applicants: Chao-Chien HUANG, Hsin-Chu (TW); Ming-Tsan KAO, Hsin-Chu (TW)

(72) Inventors: Chao-Chien HUANG, Hsin-Chu (TW); Ming-Tsan KAO, Hsin-Chu (TW)

(73) Assignee: PixArt Imaging Inc., Hsin-Chu County (TW)

(21) Appl. No.: 13/890,807

(22) Filed: May 9, 2013

(30) Foreign Application Priority Data
Jun. 13, 2012 (TW) 101121267

(51) Int. Cl. G06F 3/038

(52) U.S. Cl. CPC G06F 3/038
USPC 345/158

(57) ABSTRACT

A cursor control device includes an image sensor, at least one button, a processing unit, a selection unit and a transmitter. The image sensor captures a plurality of image frames. The at least one button outputs a trigger signal while being pressed. The processing unit calculates a displacement according to the image frames and outputs a control signal according to the trigger signal. The selection unit selects one of at least two different cursor lock periods. The transmitter outputs the control signal and the displacement, wherein the processing unit controls the transmitter to output zero displacement within the cursor lock period selected after receiving the trigger signal. The present disclosure further provides a cursor control system.

### CROSS REFERENCE TO RELATED APPLICATION

This application claims the priority benefit of Taiwan Patent Application Serial Number 101121267, filed on Jun. 13, 2012, the full disclosure of which is incorporated herein by reference.

### BACKGROUND

1. Field of the Disclosure

This disclosure generally relates to a human-machine interface device and, more particularly, to a cursor control device and system capable of adjusting a cursor lock period.

2. Description of the Related Art

Traditionally, an image display, such as a TV is configured to display sequential images and a user can only unidirectionally control output parameters of the image display, such as the volume, channel and brightness, by using buttons on a remote controller, but interactive functions are not included therein.

However, with the maturity of the multimedia technologies, the smart TV integrating various functions has become an important next-generation product. Meanwhile, in order to simplify the control procedure of the remote controller it is able to control a cursor shown on a display screen with the remote controller so as to realize the multifunction control.

For example referring to FIG. 1, it shows an interactive image system including a display screen 91 and a remote controller 92, wherein the display screen 91 shows a cursor 911 for being controlled by the remote controller 92 and a plurality of buttons 921 are formed on the remoter controller 92. For example, when the remote controller 92 is moved toward an arrow direction as shown, the cursor 911 is also moved to the position 911′ simultaneously.

Because a position of the cursor 911 changes with a pointing direction of the remote controller 92, when a user presses any button 921 on the remote controller 92 with his or her finger, the pointing direction of the remote controller 92 can be changed so that the position of the cursor 911 is also changed simultaneously. In some conditions, the function to be executed by pressing a button, e.g. icon selection, may not be able to be executed if the cursor is dragged at the time the button is being pressed thereby introducing errors in operation.

Accordingly, the present disclosure further provides a cursor control device and system that can select whether to execute a cursor lock function and select a cursor lock period.

### SUMMARY

The present disclosure provides a cursor control device that may select a cursor lock function with a selection unit and adjust a cursor lock period.

The present disclosure further provides a cursor control system that may determine a cursor lock period according to a currently executed application.

The present disclosure provides a cursor control device including an image sensor, at least one button, a processing unit, a selection unit and a transmitter. The image sensor is configured to capture a plurality of image frames. The at least one button is configured to output a trigger signal while being pressed. The processing unit is configured to calculate a displacement and/or a cursor coordinate according to the image frames and output a control signal according to the trigger signal. The selection unit is configured to select one of at least two different cursor lock periods. The transmitter is configured to output the control signal and the displacement and/or the cursor coordinate, wherein the processing unit controls the transmitter to output zero displacement or not to update the cursor coordinate within the selected cursor lock period after receiving the trigger signal.

The present disclosure further provides a cursor control system including an image display and a cursor control device. The image display includes a display screen and a host. The display screen shows a cursor. The host is configured to control a motion of the cursor and transmit a selection signal according to an application. The cursor control device includes an image sensor, at least one button, a receiver, a processing unit and a transmitter. The image sensor is configured to capture a plurality of image frames. The at least one button is configured to output a trigger signal while being pressed. The receiver is configured to receive the selection signal. The processing unit is configured to calculate a displacement and/or a cursor coordinate according to the image frames, output a control signal according to the trigger signal and select one of at least two different cursor lock periods according to the selection signal. The transmitter is configured to output the control signal and the displacement and/or the cursor coordinate to the host, wherein the processing unit controls the transmitter to output zero displacement or not to update the cursor coordinate within the selected cursor lock period after receiving the trigger signal.

The present disclosure further provides a cursor control system including an image display and a cursor control device. The image display includes a display screen and a host. The display screen shows a cursor. The host is configured to control a motion of the cursor and select one of at least two different cursor lock periods according to an application. The cursor control device includes an image sensor, at least one button, a processing unit and a transmitter. The image sensor is configured to capture a plurality of image frames. The at least one button is configured to output a trigger signal while being pressed. The processing unit is configured to calculate a displacement and/or a cursor coordinate according to the image frames, and output a control signal according to the trigger signal. The transmitter is configured to output the control signal and the displacement and/or the cursor coordinate to the host, wherein the host ignores the displacement and/or the cursor coordinate received within the selected cursor lock period after receiving the control signal.

In an aspect, the transmitter may output the control signal and the displacement and/or the cursor coordinate with a report rate, and the cursor lock period may be 5 to 20 times of a reciprocal of the report rate.

In another aspect, the cursor lock period may be a report time.

In the cursor control device and system of the present disclosure, the control signal is configured to control output parameters of the image display, such as the display brightness, channel selection, volume selection, function switching, game parameters and/or icon selection.

In the cursor control device and system of the present disclosure, the cursor lock period may be selected by a user with a selection unit, e.g. a button, a select switch or a turning knob, or may be automatically selected according to an application executed by the image display, e.g. a game program or a web browsing program, so as to improve the cursor control. In addition, the cursor lock period may further includes an unlock period; that is, the cursor may or may not be locked according to the user selection or the executed application so as to increase the applicability of the system.

### BRIEF DESCRIPTION OF THE DRAWINGS

Other objects, advantages, and novel features of the present disclosure will become more apparent from the following detailed description when taken in conjunction with the accompanying drawings.

FIG. 1 shows a schematic diagram of the conventional interactive image system.

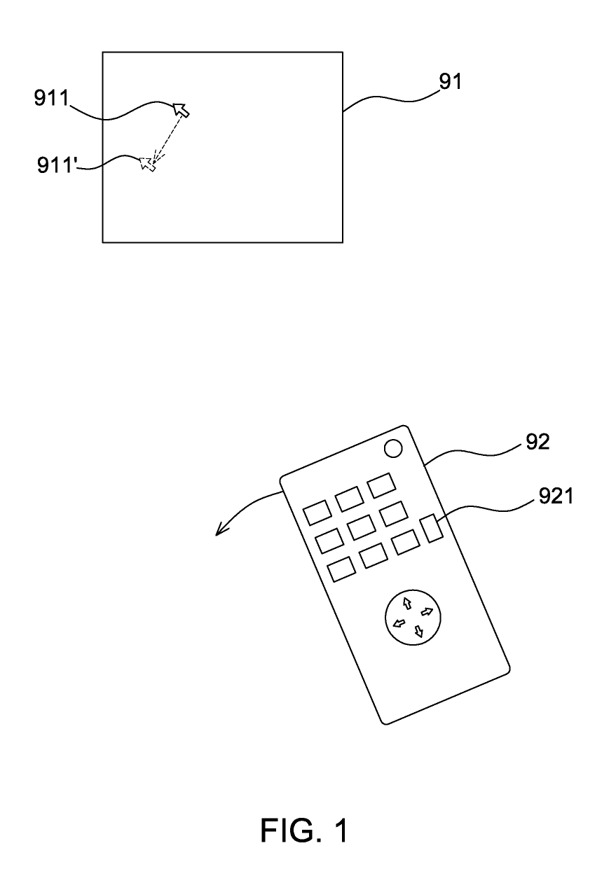

FIG. 2 shows a schematic block diagram of the cursor control device and system according to an embodiment of the present disclosure.

FIG. 3 shows a schematic block diagram of the cursor control device and system according to another embodiment of the present disclosure.

FIG. 4 shows an operational schematic diagram of the cursor control system according to the embodiment of the present disclosure.

FIG. 5 shows another operational schematic diagram of the cursor control system according to the embodiment of the present disclosure.

### DETAILED DESCRIPTION OF THE EMBODIMENT

It should be noted that, wherever possible, the same reference numbers will be used throughout the drawings to refer to the same or like parts.

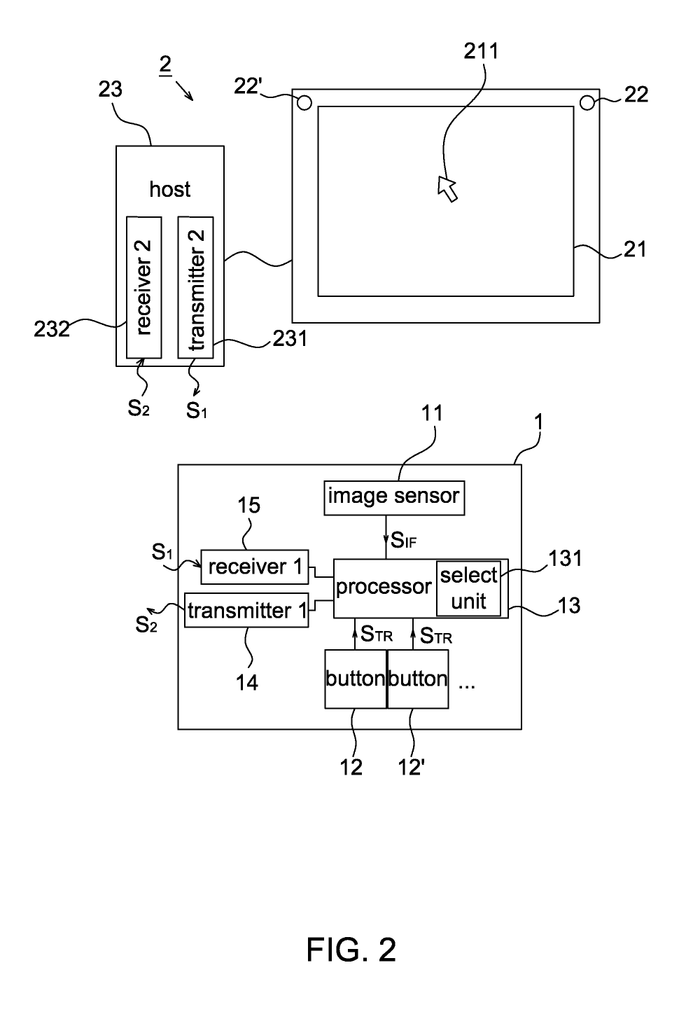

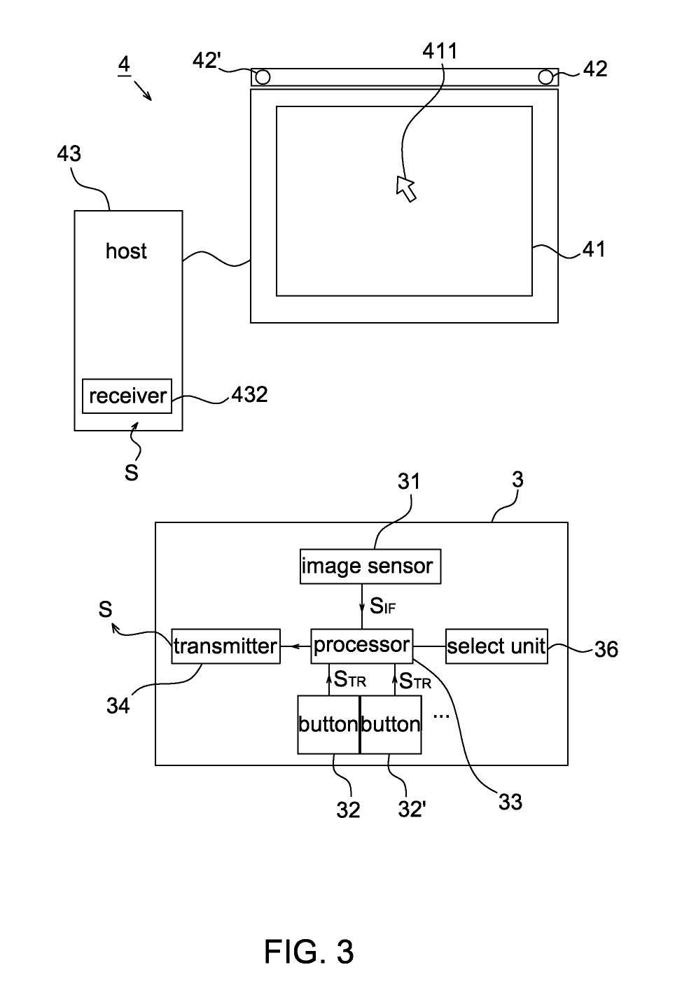

Referring to FIGS. 2 and 3, they respectively show a schematic block diagram of the cursor control system according to an embodiment of the present disclosure including a cursor control device and an image display. The cursor control device may be a remote controller such as an optical navigation device or an optical pointing device, and is configured to calculate a relative movement of the cursor control device with respect to the image display according to the captured image frames to control the motion of a cursor shown on the image display and further configured to adjust or select at least one output parameter of the image display according to a pressing state of at least one button, e.g. the display brightness, channel selection, volume selection, function switching, game parameters, icon selection and/or other outputs controlled by pressing buttons. In one embodiment, the cursor control system may be a smart TV, a projection device or a computer device capable of operating interactively with a remote controller by means of controlling a cursor shown on a display screen.

Referring to FIG. 2, it shows a schematic block diagram of the cursor control system according to an embodiment of the present disclosure, which includes a cursor control device 1 and an image display 2.

The cursor control device 1 includes an image sensor 11, at least one button (e.g. two buttons 12 and 12′ are shown herein), a processing unit 13, a first transmitter 14 and a first receiver 15. The image display 2 includes a display screen 21 and a host 23; the display screen 21 may show a cursor 211; and the host 23 may include a second transmitter 231 and a second receiver 232. It is appreciated that the host 23 and the display screen 21 may form a single device (e.g. a smart TV) or two devices coupled to each other (e.g. a computer system). In other words, when the host 23 is integrated with the display screen 21 to form a signal device, the host 23 in the descriptions of the present disclosure is referred to the image display 2. In addition, according to the method of calculating displacement and/or cursor coordinates used by the cursor control device 1, at least one reference point (e.g. two reference points 22 and 22′ are shown herein) is further integrated with or disposed close to the image display 2, wherein the at least one reference point may emit or reflect red light, infrared light or other invisible light. In other embodiments, the image display 2 may not include any additional reference point; in this case the corner or the edge of the display screen 21 or the predetermined point of the image display 2 may be served as the reference point.

The image display 2 may show the cursor 211. The host 23 is configured to control the motion of the cursor 211 and to generate a selection signal S₁ according to an application executed thereby. More specifically speaking, the host 23 may send the selection signal S₁ through the second transmitter 231, wherein the selection signal S₁ may be wired or wirelessly sent to the cursor control device 1 and is configured to allow the cursor control device 1 to select a cursor lock period accordingly (described later). The host 23 may generate a corresponding selection signal S₁ according to different applications executable by a general display device, e.g. a game program or a web browsing program, but not limited thereto. The second receiver 232 may wired or wirelessly receive control data S₂ from the cursor control device 1, e.g. including displacement, cursor coordinates or control signals. The host 23 may correspondingly control the image display 2 according to the control data S₂ received by the second receiver 232. It is appreciated that the transmitter and the receiver may be combined as a transceiver, and the wired and wireless transmission techniques are well known and thus details thereof are not described herein.

In the cursor control device 1, the image sensor 11 may be a CCD image sensor, a CMOS image sensor or other sensors capable of detecting optical energy, and is configured to capture a plurality of image frames. For example, the image sensor 11 sequentially captures and outputs image frames S_{IF} containing at lest one reference point 22 and 22′ or at least a part of the image display 2 at a sampling frequency, wherein contents should be included in the image frames S_{IF} may be determined according to the method of calculating the displacement and/or the cursor coordinates.

The at least one button 12 and 12′ is configured to output a trigger signal S_{TR} while being pressed, wherein the processing unit 13 is able to distinguish different trigger signals outputted when one button or a group of buttons are pressed. The method of distinguishing a button or buttons being pressed using a processing unit is well known and thus details thereof are not described herein.

The first receiver 15 is configured to receive the selection signal S₁ from the image display 2 and transmit the selection signal S₁ to the processing unit 13.

The processing unit 13 is coupled to the image sensor 11, the buttons 22, 22′ and the receiver 15, and configured to calculate a displacement and/or a cursor coordinate according to the image frames S_{IF}, to output a control signal according to the trigger signal S_{TR} and to select one of at least two different cursor lock periods according to the selection signal S₁. For example, when the application is a game program, the processing unit 13 may shorten the cursor lock period or set the cursor lock period to zero according to the selection signal S₁; and when the application is a web browsing program, the processing unit 13 may extend the cursor lock period according to the selection signal S₁. In other words, when the operation of the application does not need to cooperate with the cursor dragging, the processing unit 13 may extend the cursor lock period according to the selection signal S₁; and when the operation of the application may cooperate with cursor dragging or can tolerate slight cursor dragging, the processing unit 13 may shorten the cursor lock period according to the selection signal S₁ or may even not lock the cursor. In the present disclosure, whether or not an application can cooperate with the cursor lock may be previously determined. The control signal is configured to control an output parameter of the image display.

The first transmitter 14 is also coupled to the processing unit 13 and configured to output control data S₂, e.g. including the control signal and the displacement and/or the cursor coordinate, to the host 23 of the image display 2.

In this embodiment, the processing unit 13 controls the transmitter 14 to output zero displacement or to stop updating the cursor coordinate within the selected cursor lock period after receiving the trigger signal S. In the present disclosure, the processing unit 13 itself may output zero displacement or a fixed cursor coordinate, or the processing unit 13 may control the transmitter 14 not to update the displacement and/or the cursor coordinate to be outputted.

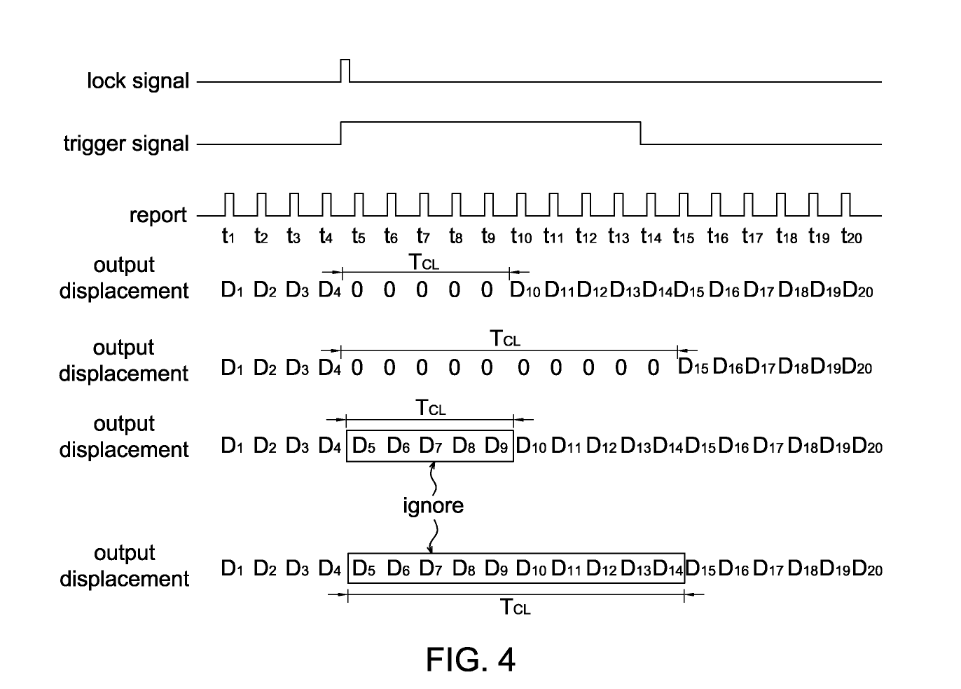

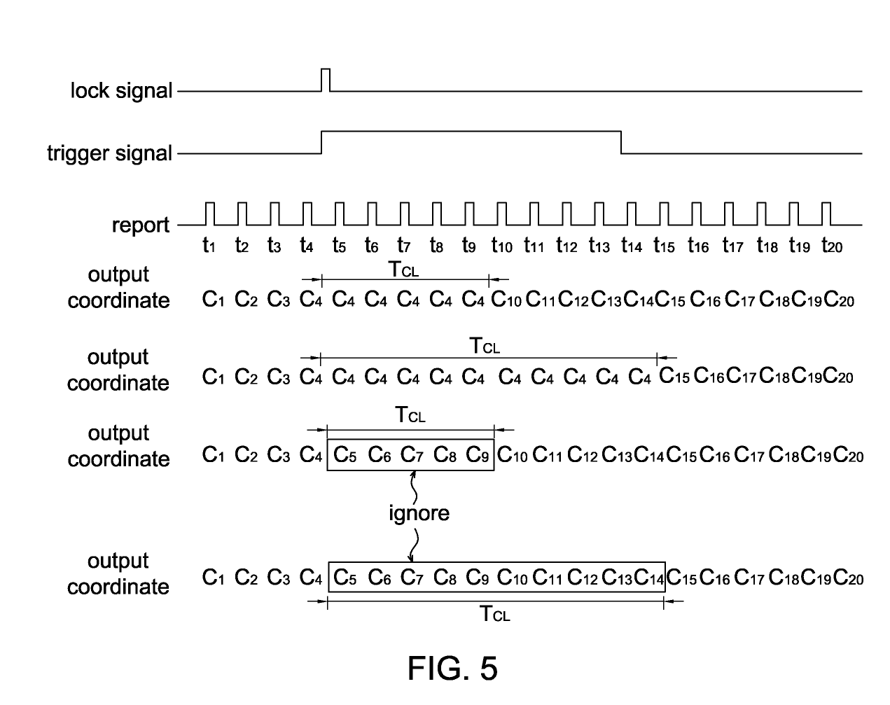

For example referring to FIGS. 4 and 5, they respectively show an operational schematic diagram of the cursor control system according to the embodiment of the present disclosure. The first transmitter 14 may output the control signal and the displacement and/or the cursor coordinate with a report rate (i.e. times per second data is outputted), wherein it is assumed that the processing unit 13 receives the trigger signal S_{TR} after time t₄. Therefore, at times t₁-t₄ the processing unit 13 controls the first transmitter 14 to continuously update the displacement and/or the cursor coordinate. After the time t₄, the processing unit 13 controls (e.g. sending a lock signal) the first transmitter 14 to output zero displacement (FIG. 4) or to stop updating the cursor coordinate (FIG. 5) within the selected cursor lock period T_{CL}, e.g. outputting zero displacement or a fixed cursor coordinate at times t₅-t₉ or t₅-t₁₄, and to restart to continuously update the displacement and/or the cursor coordinate when the cursor lock period T_{CL} is over. It should be mentioned that a duration of the trigger signal S_{TR} and the cursor lock period T_{CL} do not have direct relationship. The duration of the trigger signal S_{TR} is determined according to a time interval that the user presses on the button and the cursor lock period T_{CL} is one of at least two different values. When the transmitter 14 is configured to output the cursor coordinate, within the cursor lock period T_{CL} the processing unit 13 controls the first transmitter 14 to output a previous cursor coordinate (e.g. the coordinate C₄ shown in FIG. 5) obtained before the trigger signal S_{TR} is received. In one embodiment, the cursor lock period T_{CL} may be 5-20 times of a reciprocal of the report rate. For example, when a reciprocal of the report rate is 10 ms, the cursor lock period T_{CL} may be between 50 ms to 200 ms. In another embodiment, the cursor lock period T_{CL} may be a report time, e.g. 5-20 times. In another embodiment, the cursor lock period T_{CL} may further include an unlock period. In other words, in this embodiment the processing unit 13 may determine a cursor lock period T_{CL} or may not lock the cursor 211 according to an application executed by the image display 2. In another embodiment, the processing unit 13 may further include a selection unit 131 which may select the cursor lock period T_{CL} according to the selection signal S₁ from the image display 2 and received by the first receiver 15.

In this embodiment, the image display 2 informs the cursor control device 1 to select a proper cursor lock period T_{CL} according to an application executed. The cursor control device 1 may output zero displacement or stop updating the cursor coordinate within the selected cursor lock period T_{CL}.

Referring to FIG. 3, it shows a schematic block diagram of the cursor control system according to another embodiment of the present disclosure, which includes a cursor control device 3 and an image display 4.

The cursor control device 3 includes an image sensor 31, at least one button (e.g. two buttons 32 and 32′ are shown herein), a processing unit 33, a transmitter 34 and a selection unit 36. The image display 4 includes a display screen 41 and a host 43. The display screen 41 may show a cursor 411. The host 43 may include a receiver 432. As mentioned above, in this embodiment the host 43 may also be integrated with the display screen 43 or separated therefrom. In addition, in this embodiment the reference points 42 and 42′ are shown to be disposed on an independent device. Similarly, the reference points 42 and 42′ may not be implemented according to the method of calculating the displacement and/or the cursor coordinate used by the cursor control device 3.

The image display 4 may show the cursor 411. The host 43 is configured to control the motion of the cursor 411 and to control displayed contents and output parameters of the display screen 41. The receiver 432 wired or wirelessly receives control data S from the cursor control device 3, e.g. including the displacement, cursor coordinates or control signals. The host 43 correspondingly controls the image display 4 according to the control data S received by the receiver 432.

Similar to the previous embodiment, the image sensor 31 is configured to capture and output a plurality of image frames S_{IF}; the at least one button is configured to output a trigger signal S_{TR} while being pressed; and the processing unit 33 is configured to calculate a displacement and/or a cursor coordinate according to the image frames S_{IF} and output a control signal according to the trigger signal S_{TR}. The transmitter 34 is configured to output the control data S to the image display 4 and the control data S is received by the receiver 432 of the host 43.

The selection unit 36 is configured to select one of at least two different cursor lock periods. In one embodiment, the selection unit 36 may be a button, a select switch, a turning knob, a mechanical switch or an electric switch such that a user may select a desired cursor lock period, wherein the cursor lock period may include at least two different nonzero cursor lock periods or further include a zero cursor lock period (i.e. the cursor lock period is 0).

In this embodiment, the processing unit 33 controls the transmitter 34 to output zero displacement or to stop updating the cursor coordinate within the selected cursor lock period after receiving the trigger signal S_{TR}. The control method is similar to the previous embodiment.

Referring to FIGS. 4 and 5 again, the transmitter 34 may output the control signal and the displacement and/or the cursor coordinate with a report rate. Similarly, at times t₁-t₄ the processing unit 33 controls the transmitter 34 to continuously update the displacement and/or the cursor coordinate. Then, after the time t₄, the processing unit 33 controls the transmitter 34 to output zero displacement (FIG. 4) or to stop updating the cursor coordinate (FIG. 5) within the selected cursor lock period T_{CL}, e.g. outputting zero displacement or a fixed cursor coordinate at times t₅-t₉ or t₅-t₁₄, and to continuously update the displacement and/or the cursor coordinate after the cursor lock period T_{CL}. When the transmitter 34 is configured to output the cursor coordinate, within the cursor lock period T_{CL} the processing unit 33 may control the transmitter 34 to output a previous cursor coordinate (e.g. the coordinate C₄ in FIG. 5) obtained before the trigger signal S_{TR} is received.

The difference between this embodiment and FIG. 2 is that the cursor lock period T_{CL} is controlled by the cursor control device 3 rather than determined by the image display 4, and functions and operations of other components are similar. For example, the cursor lock period T_{CL} may also be 5-20 times of a reciprocal of the report rate; the cursor lock period T_{CL} may also be a report time; and the control signal may also be configured to control an output parameter of the image display and thus details thereof are not repeated herein. In this embodiment, the cursor control device 3 may further include a receiver configured to communicate with the image display 4 and the image display 4 may further include a transmitter configured to communicate with the cursor control device 3. Or the cursor control device 3 and the image display 4 may communicate with each other through a transceiver.

Referring to FIG. 3 again, in another embodiment the host 43 may also be configured to control the motion of the cursor 411 and to select one of at least two different cursor lock periods according to an application executed thereby; that is, in this embodiment the cursor control device 3 may not include the selection unit 36. Similarly, the image sensor 31 is configured to capture a plurality of image frames S_{IF}; and the at least one button 32 and 32′ is configured to output a trigger signal S_{TR} when it is pressed. When the processing unit 33 calculates the displacement and/or the cursor coordinate according to the image frames S_{IF} and outputs the control signal according to the trigger signal S_{TR}, the transmitter 34 then outputs control data S, e.g. including the control signal and the displacement and/or the cursor coordinate, to the host 43. The host 43 ignores the received displacement and/or cursor coordinates within the selected cursor lock period after receiving the control signal.

Referring to FIGS. 4 and 5 again, the transmitter 34 may output the control signal and the displacement and/or the cursor coordinate with a report rate. Similarly, at times t₁-t₄ the host 43 controls the display screen 41 to continuously update the displacement and/or the cursor coordinate. Then after the time t₄, the host 43 ignores the displacement (FIG. 4) and/or the cursor coordinates (FIG. 5) within the selected cursor lock period T_{CL}, e.g. ignoring the displacement D₅-D₉ or D₅-D₁₄ or ignoring the cursor coordinates C₅-C₉ or C₅-C₁₄ at times t₅-t₉ or t₅-t₁₄, and to continuously update the displacement and/or the cursor coordinate after the cursor lock period T_{CL}, wherein in the cursor lock period T_{CL} the host 43 may set the cursor coordinate as a previous cursor coordinate (e.g. the coordinate C₄ in FIG. 5) obtained before the control signal is received such that the position of the cursor 411 may be fixed. In the present disclosure, the host 23 itself may output zero displacement or a fixed cursor coordinate, or the display screen 21 may be controlled not to update the displacement and/or the cursor coordinate to be outputted.

The difference between this embodiment and FIG. 2 is that the cursor control device 3 continuously outputs the updated displacement and/or cursor coordinates and the host 43 ignores the updated displacement and/or cursor coordinates sent from the cursor control device 3 within the cursor lock period T_{CL} according to an application; that is, the cursor lock period is determined by the host 43. For example, when the application is a game program, the host 43 may shorten the cursor lock period T_{CL} or set the cursor lock period T_{CL} to zero; and when the application is a web browsing program, the host 43 may extend the cursor lock period T_{CL}. In other words, when the operation of the application does not need to cooperate with the cursor dragging, the host 23 may extend the cursor lock period T_{CL}; and when the operation of the application may cooperate with the cursor dragging or can tolerate slight cursor dragging, the host 23 may shorten the cursor lock period T_{CL} or may even not lock the cursor. In this embodiment, functions and operations of other components are similar to the previous embodiment. For example, the cursor lock period T_{CL} may also be 5-20 times of a reciprocal of the report rate; the cursor lock period T_{CL} may also be a report rate; and the cursor lock period T_{CL} may include an unlock period, and thus details thereof are not repeated herein.

It is appreciated that the number of components and the value of parameters in the above embodiments are only exemplary and not used to limit the present disclosure.

As mentioned above, in the conventional interactive image system the cursor may be dragged when a push button is being pressed to cause control errors. Therefore, the present disclosure further provides a cursor control device and system (FIGS. 2 and 3) that may determine a cursor lock period with a selection unit or according to an application so as to improve the smoothness and applicability of the cursor control.

Although the disclosure has been explained in relation to its preferred embodiment, it is not used to limit the disclosure. It is to be understood that many other possible modifications and variations can be made by those skilled in the art without departing from the spirit and scope of the disclosure as hereinafter claimed.

What is claimed is:

1. A cursor control device, comprising:
an image sensor configured to capture a plurality of image frames;
at least one button configured to output a trigger signal while being pressed;
a processing unit configured to calculate at least one of a displacement and a cursor coordinate according to the image frames and output a control signal according to the trigger signal;
a selection unit configured to select one of at least two different cursor lock periods; and
a transmitter configured to output the control signal and at least one of the displacement and the cursor coordinate, wherein the processing unit controls the transmitter to output zero displacement or not to update the cursor coordinate within the cursor lock period selected after receiving the trigger signal.

2. The cursor control device as claimed in claim 1, wherein the selection unit is a mechanical switch or an electrical switch.

3. The cursor control device as claimed in claim 1, wherein the selection unit further selects the cursor lock period as 0 second.

4. The cursor control device as claimed in claim 1, wherein the transmitter outputs the control signal and at least one of the displacement and the cursor coordinate with a report rate, and the cursor lock period is 5 to 20 times of a reciprocal of the report rate.

5. The cursor control device as claimed in claim 1, wherein the cursor lock period is a report time.

6. The cursor control device as claimed in claim 1, wherein the control signal and at least one of the displacement and the cursor coordinate are sent to an image display.

7. The cursor control device as claimed in claim 6, further comprising a receiver configured to receive a selection signal from the image display, wherein the processing unit selects the cursor lock period according to the selection signal.

8. The cursor control device as claimed in claim 6, wherein the control signal is configured to control an output parameter of the image display.

9. A cursor control system, comprising:
an image display comprising:
a display screen showing a cursor;
a host configured to control a motion of the cursor and transmit a selection signal according to an application; and
a cursor control device comprising:
an image sensor configured to capture a plurality of image frames;
at least one button configured to output a trigger signal while being pressed;
a receiver configured to receive the selection signal;
a processing unit configured to calculate at least one of a displacement and a cursor coordinate according to the image frames, output a control signal according to the trigger signal and select one of at least two different cursor lock periods according to the selection signal; and
a transmitter configured to output the control signal and at least one of the displacement and the cursor coordinate to the host, wherein the processing unit controls the transmitter to output zero displacement or not to update the cursor coordinate within the cursor lock period selected after receiving the trigger signal.

10. The cursor control system as claimed in claim 9, wherein the cursor lock period further comprises an unlock period.

11. The cursor control system as claimed in claim 9, wherein when the application is a game program, the processing unit shortens the cursor lock period or sets the cursor lock period as zero according to the selection signal; and when the application is a web browsing program, the processing unit extends the cursor lock period according to the selection signal.

12. The cursor control system as claimed in claim 9, wherein the transmitter outputs the control signal and at least one of the displacement and the cursor coordinate with a report rate, and the cursor lock period is 5 to 20 times of a reciprocal of the report rate.

13. The cursor control system as claimed in claim 9, wherein the cursor lock period is a report time.

14. The cursor control system as claimed in claim 9, wherein the control signal is configured to control an output parameter of the image display.

15. A cursor control system, comprising:
an image display comprising:
a display screen showing a cursor;
a host configured to control a motion of the cursor and select one of at least two different cursor lock periods according to an application; and
a cursor control device comprising:
an image sensor configured to capture a plurality of image frames;
at least one button configured to output a trigger signal while being pressed;
a processing unit configured to calculate at least one of a displacement and a cursor coordinate according to the image frames, and output a control signal according to the trigger signal; and
a transmitter configured to output the control signal and at least one of the displacement and the cursor coordinate to the host;
wherein the host ignores at least one of the displacement and the cursor coordinate received from the transmitter within the cursor lock period selected after receiving the control signal.

16. The cursor control system as claimed in claim 15, wherein the cursor lock period further comprises an unlock period.

17. The cursor control system as claimed in claim 15, wherein when the application is a game program, the processing unit shortens the cursor lock period or sets the cursor lock period as zero according to the selection signal; and when the application is a web browsing program, the processing unit extends the cursor lock period according to the selection signal.

18. The cursor control system as claimed in claim 15, wherein the transmitter outputs the control signal and at least one of the displacement and the cursor coordinate with a report rate, and the cursor lock period is 5 to 20 times of a reciprocal of the report rate.

19. The cursor control system as claimed in claim 15, wherein the cursor lock period is a report time.

20. The cursor control system as claimed in claim 15, wherein the host sets the cursor coordinate as a previous cursor coordinate, which is received before the control signal is received, within the cursor lock period.
